(19) United States
(12) Patent Application Publication
(10) Pub. No.: US 2013/0001273 A1
(43) Pub. Date: Jan. 3, 2013

(54) MOUNTING METHOD, MOUNTING DEVICE AND MOUNTING JIG

(75) Inventor: Yoshihiro Tateiwa, Kanagawa (JP)

(73) Assignee: SUMITOMO ELECTRIC INDUSTRIES, LTD., Osaka (JP)

(21) Appl. No.: 13/534,175

(22) Filed: Jun. 27, 2012

(30) Foreign Application Priority Data
Jun. 28, 2011 (JP) 2011-143471

(51) Int. Cl. B23K 3/00; B23Q 1/64; B23K 1/00

(52) U.S. Cl. 228/101; 228/47.1; 269/56

(57) ABSTRACT

A mounting method includes: holding a component at a position off a gravity center of the component; pressing the component to a solder provided on a mount face of a substrate; and adding pressing force to an opposite position of the component across the gravity center from the position held in the pressing of the component toward the mount face, after the pressing of the component.

### CROSS-REFERENCE TO RELATED APPLICATION

This application is based upon and claims the benefit of priority of the prior Japanese Patent Application No. 2011-143471, filed on Jun. 28, 2011, the entire contents of which are incorporated herein by reference.

### BACKGROUND

(i) Technical Field

The present invention relates to a mounting method, a mounting device and a mounting jig.

(ii) Related Art

When a component such as a semiconductor chip is mounted on a substrate, it is necessary to press the component to the substrate in order to absolutely fix the component and correct parallelism of the component. Japanese Patent Application Publication No. 2008-161995 (hereinafter referred to as Document 1) discloses a pair of component-mounting tweezers having a projection portion for pressing an electronic component from above.

### SUMMARY

However, with the method of Document 1, when a component is mounted with use of a solder, the component may be inclined with respect to the substrate because of pressure of the solder. When the component is arranged in parallel with the substrate, the component may be damaged by burden to which the component is subjected. If it takes long time to mount the component, a problem such as oxidation or hyperactivation of the solder may occur.

It is an object to provide a mounting method, a mounting device and a mounting jig that restrain damage of a component and are capable of mounting a component on a substrate in parallel with the substrate efficiently.

According to an aspect of the present invention, there is provided a mounting method including: holding a component at a position off a gravity center of the component; pressing the component to a solder provided on a mount face of a substrate; and adding pressing force to an opposite position of the component across the gravity center from the position held in the pressing of the component toward the mount face, after the pressing of the component.

According to another aspect of the'present invention, there is provided a mounting device including: a holding member to hold a component off a gravity center thereof; and an auxiliary member to add pressing force to an opposite position across the gravity center from the position held by the holding member, the auxiliary member adding pressing force to the component toward a mount face of a substrate after pressing the component to the mount face with the component being held by the holding member, a solder being sandwiched between the component and the mount face of the substrate.

According to another aspect of the present invention, there is provided a mounting jig including: two main arms to hold two side faces of a component facing each other; and an auxiliary arm to move in a direction that is vertical to a moving direction of the two main arms.

### BRIEF DESCRIPTION OF THE DRAWINGS

FIG. 11 illustrates a perspective view of tweezers in accordance with a comparative example;

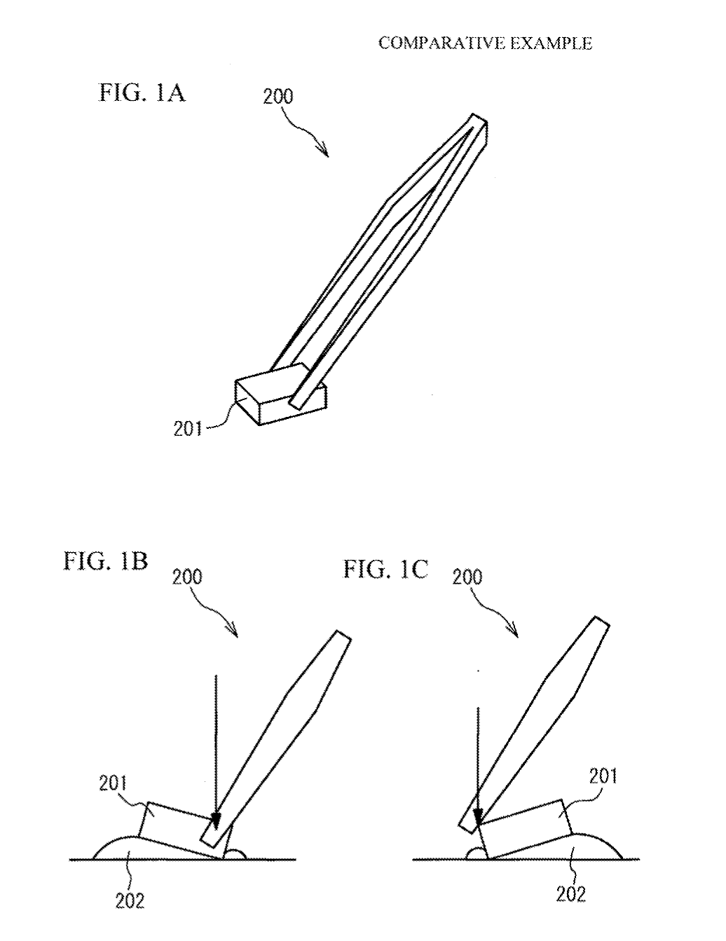

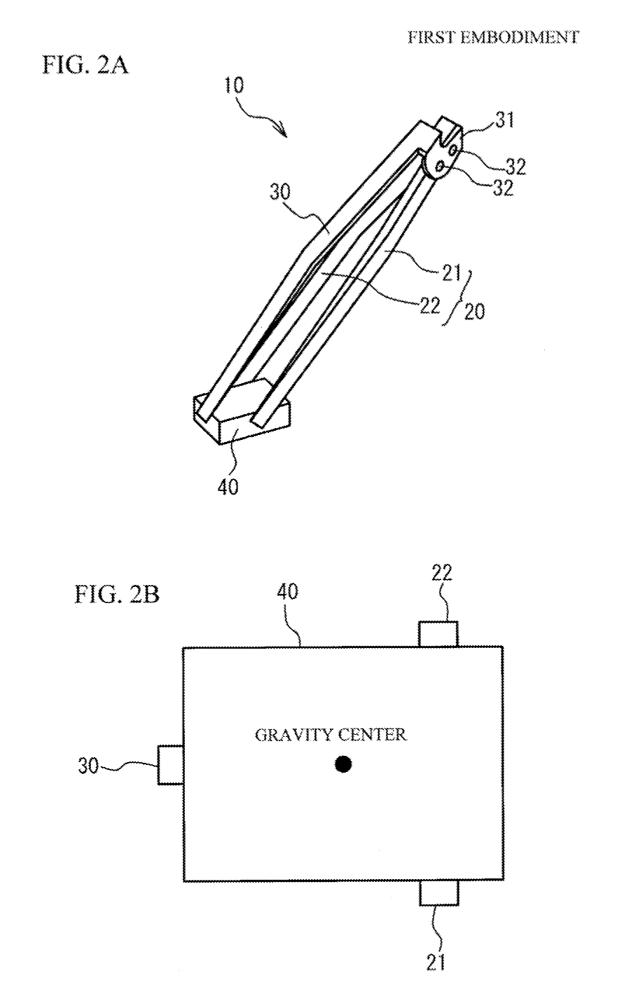

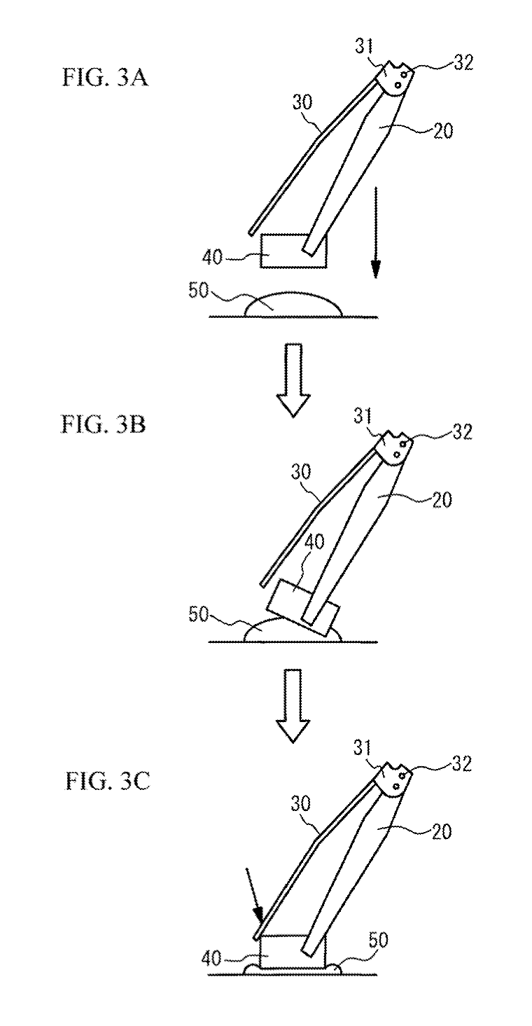

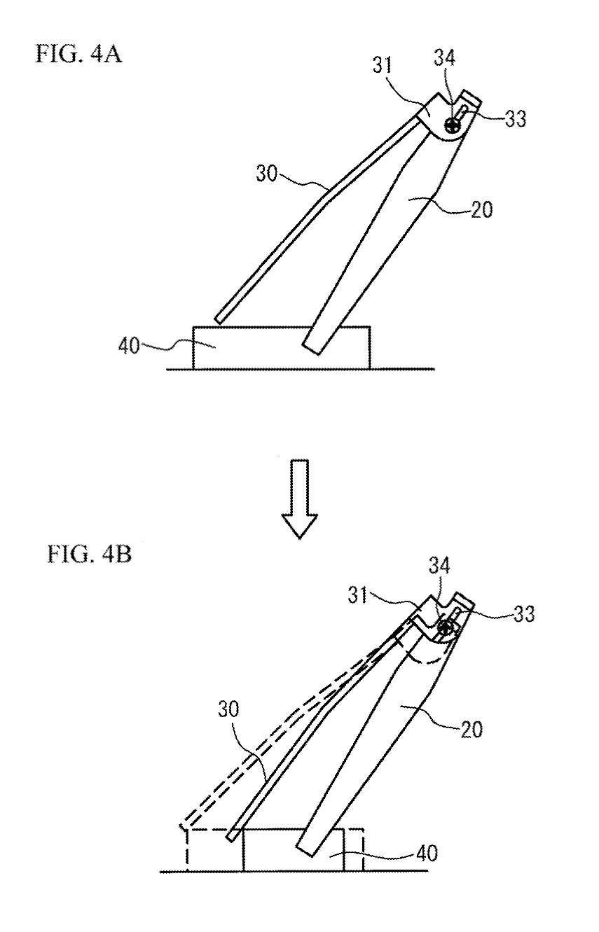

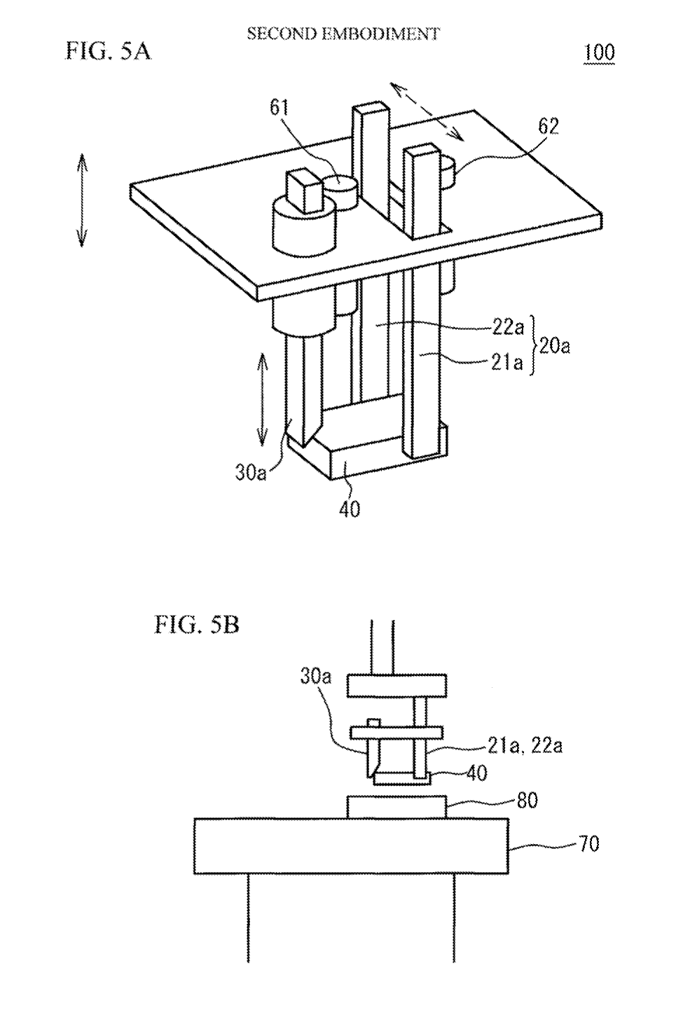

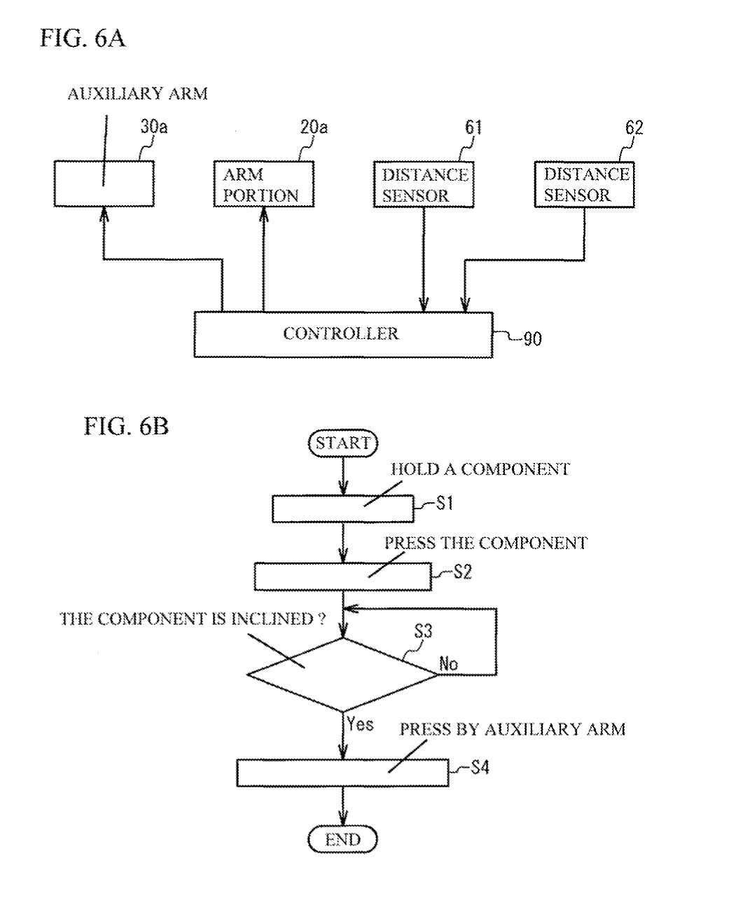

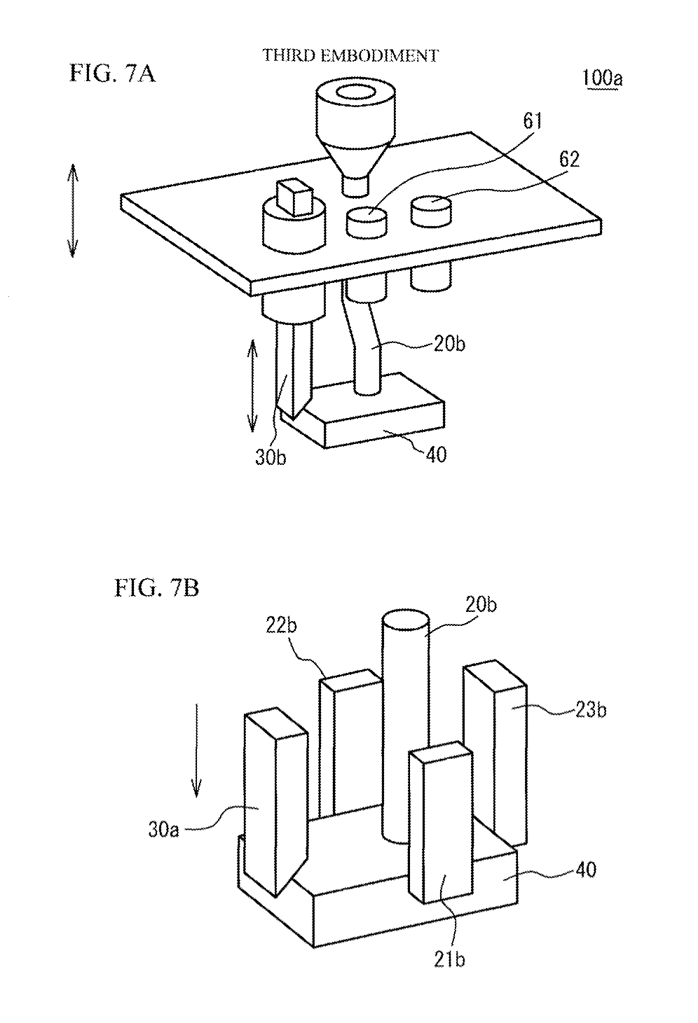

FIG. 1B and FIG. 1C illustrate a perspective view of a component;

FIG. 2A illustrates a perspective view of a mounting jig in accordance with a first embodiment;

FIG. 2B illustrates held positions of the component;

FIG. 3A through FIG. 3C illustrate a mounting method of the component;

FIG. 4A and FIG. 4B illustrate a modified embodiment of the mounting jig;

FIG. 5A illustrates a perspective view of a mounting device in accordance with a second embodiment;

FIG. 5B illustrates a use example of the mounting device;

FIG. 6A illustrates a block diagram of a control system of the mounting device;

FIG. 6B illustrates a flow chart of an example of a control of a controller; and

FIG. 7A and FIG. 7B illustrate a perspective view of a mounting device in accordance with a modified embodiment.

### DETAILED DESCRIPTION

### Comparative Example

A description will be given of tweezers 200 in accordance with a comparative example before describing embodiments. FIG. 1A illustrates a perspective view of the tweezers 200. When a rectangular parallelepiped component 201 is held by two arms of the tweezers 200, two faces facing each other are held. In the example of FIG. 1A, side faces of the component 201 facing each other are held. A description will be given of mounting the component 201 on a substrate with use of the tweezers 200. An objective component is a semiconductor chip or the like. When the component is a semiconductor light-receiving chip, the component is a square 500 μm on a side, has a thickness of 140 to 150 μm, and has a weight of 170 to 180 μg. There is a problem as follows, in a case where a micro semiconductor chip is treated.

When the component 201 is mounted on the substrate, the component 201 is arranged on the substrate after coating a solder 202 on the substrate. For example, the solder 202 is AuSn or Ag paste. The solder 202 is fluidized when the component 201 is located on the solder 202. In a case using the AuSn solder, the solder 202 is fluidized by melting process. In this case, as illustrated in FIG. 1B, the component 201 is subjected to buoyant force caused by the pressure of the solder 202. When the tweezers 200 are used, the component 201 is pressed to a mount face of the substrates in a direction vertical to the mount face with the side faces being held. In this case, the held portion of the side faces of the component 201 is slippery, and the component 201 tends to be inclined. If an amount of the solder 202 is reduced, the inclination of the component 201 may be restrained. However, in this case, adhesive strength of the component 201 may be reduced.

The component 201 may be mounted on the substrate in parallel with the substrate by separating the tweezers 200 from the component 201 once in order to adjust the postural condition of the component 201 and pressing floating corners (sides) of an upper face of the component 201 as illustrated in FIG. 1C. However, in this case, the component 201 is inclined to the opposite side. And, the component 201 may be damaged, because the component 201 is subjected to the force intensively.

The component 201 is unstable in a parallel direction with respect to the mount face of the substrate. It is therefore necessary to adjust a position of the component 201. That is, it is necessary to adjust the position separately in addition to adjusting the postural condition of the component 201 as illustrated in FIG. 1B and FIG. 1C. In this case, it takes long time to adjust the postural condition and the position. Therefore, a trouble such as oxidation or hyperactivation of the solder may occur.

And so, a description will be given of a mounting jig, a mounting device and a mounting method that restrain a damage of a component and are capable of mounting a component on a substrate in parallel with the substrate efficiently.

### First Embodiment

FIG. 2A illustrates a perspective view of a mounting jig 10 in accordance with a first embodiment. As illustrated in FIG. 2A, the mounting jig 10 has an arm portion 20 and an auxiliary arm 30. The arm portion 20 has two main alms 21 and 22. The auxiliary arm 30 is capable of moving in a direction vertical to a holding direction of the main arms 21 and 22 with respect to a component 40. The auxiliary arm 30 is coupled to a portion of the arm portion 20 where the main arms 21 and 22 are connected to each other via a connection portion 31. The connection portion 31 is fixed to the arm portion 20 by a fixing pin 32. The two main arms 21 and 22 are capable of holding side faces of the component 40 facing each other. Another portion that is different from the portion of the component 40 held by the main arms 21 and 22 is subjected to a pressing force, because the auxiliary arm 30 is capable of moving in the direction vertical to the holding direction of the main arms 21 and 22 with respect to the component 40. In the example of FIG. 2A, the auxiliary arm 30 is capable of adding a pressing force to a corner of another side face that is different from the side faces held by the main arms 21 and 22.

It is possible to add the pressing force to the component 40 stably when the positions of the component 40 held by the two main arms 21 and 22 is across a gravity center of the component 40 from another position of the component 40 to which the pressing force is added by the auxiliary arm 30, as illustrated in FIG. 2B. That is, a line connecting the positions of the component 40 held by the main arms 21 and 22 is across the gravity center of the component 40 from another position of the component 40 to which the suppress force is added from the auxiliary arm 30.

FIG. 3A through FIG. 3C illustrate a mounting method of the component 40. As illustrated in FIG. 3A, a solder 50 is coated on a mount face of a substrate. For example, the solder 50 is AuSn or Ag paste. The solder 50 is fluidized when the component 40 is located on the solder 50. In a case using the AuSn solder, the solder 50 is fluidized by melting process. After that, the component 40 is held by the arm portion 20 of the mounting jig 10, and the component 40 is pressed to the mount face of the substrate. In this case, as illustrated in FIG. 3B, the component 40 is inclined with respect to the mount face of the substrate, because the arm portion 20 holds a position of the component 40 off the gravity center thereof and the component 40 is subjected to the pressure of the solder 50. In concrete, the opposite side of the component 40 across the gravity center from the position held by the two main arms 21 and 22 floats.

And so, as illustrated in FIG. 3C, the auxiliary arm 30 adds pressing force to a corner of another side face that is different from those held by the main arms 21 and 22. In this case, as illustrated in FIG. 2B, the component 40 is held so that the positions held by the two main arms 21 and 22 are across the gravity center of the component 40 from the position pressed by the auxiliary arm 30. In this case, floating of the component 40 is restrained. Therefore, the component 40 is mounted in parallel with the mount face of the substrate.

In accordance with the embodiment, the function of the main portion (the main arms 21 and 22) for holding the component 40 is different from that of the auxiliary portion (the auxiliary arm 30) adding the pressing force in order to adjust the angle of the component 40. The position of the component 40 is fixed with respect to the mount face of the substrate, because it is not necessary to move the component 40 held by the main portion. It is therefore not necessary to adjust the position of the component 40 additionally.

The auxiliary position side floats when the component 40 is pressed to the solder 50, if the position across the gravity center from the auxiliary position is held when the component 40 is held by the main portion. This allows that the inclination direction of the component 40 can be kept constant. It is therefore possible to correct the parallelism of the component 40 by pressing the floating portion with the auxiliary portion. A precise control such as correcting of parallelism can be achieved, because the auxiliary portion and the main portion can be operated independently. When the correcting of parallelism is achieved, accuracy of connecting of a bonding wire to the component 40 is improved. The posture of the component 40 can be easily adjusted even if a sufficient amount of the solder 50 is used. Therefore, adhesion strength degradation of the component 40 caused by reduction of the amount of the solder 50 for preventing of the posture fluctuation of the component 40 can be restrained.

The position adjusting and the posture adjusting can be achieved even if the mounting jig 10 is not detached from the component 40. A time necessary for the position adjusting and the posture adjusting can be shortened. It is therefore possible to mount the component 40 efficiently. The component 40 is not subjected to an excessive burden, because the component 40 is held at the positions across the gravity center thereof. It is therefore possible to restrain the damage with respect to the component 40.

It is preferable that the auxiliary arm 30 is longer than the two main arms 21 and 22. In this case, it is possible to hold an object in parallel with a mount face of a substrate with the two main arms 21 and 22 of the mounting jig 10 being inclined. Therefore, user's view is not blocked, and high operation performance is achieved.

### Modified Embodiment

FIG. 4A and FIG. 4B illustrate a modified embodiment of the mounting jig 10. As illustrated in FIG. 4A, the connection portion 31 has a slid type movable portion. In concrete, a through hole 33 is formed in the connection portion 31 so that the connection portion 31 is capable of sliding with respect to the arm portion 20. A screw 34 is provided in the through hole 33. The auxiliary arm 30 is fixed to the arm portion 20 when the screw 34 is tightened after a relative position of the auxiliary arm 30 and the arm portion 20 is adjusted with use of the through hole 33. The movable portion is capable of changing a position of the component 40 held by the two main arms 21 and 22 and another position of the component 40 to which the pressing force is added from the auxiliary arm 30. That is, the movable portion acts as a position adjust portion.

For example, as illustrated in FIG. 4A, when the component 40 is large, the auxiliary arm 30 is not capable of adding the pressing force to a corner of a side face of the component 40. And so, as indicated by a dotted line of FIG. 4B, the edges of the two main arms 21 and 22 are taken away from the edge of the auxiliary arm 30. In this case, the auxiliary arm 30 is capable of adding the pressing force to the corner of the side face. Therefore, the auxiliary arm 30 is capable of covering variable sizes when the auxiliary arm 30 is movable.

### Second Embodiment

FIG. 5A illustrates a perspective view of a mounting device 100 in accordance with a second embodiment. As illustrated in FIG. 5A, the mounting device 100 has an arm portion 20a having two main arms 21a and 22a, an auxiliary arm 30a, distance sensors 61 and 62, and so on. In the embodiment, the main arms 21a and 22a are provided so as to hold side faces of the component 40 facing each other. In the embodiment, the main arms 21a and 22a get closer to each other by a motive power of an actuator or the like, and thereby hold the component 40.

The auxiliary arm 30a is provided so as to move in a vertical direction with respect to the component 40. A position of the component 40 to which pressing force is added by the auxiliary arm 30a is across the gravity center of the component 40 from other positions of the component 40 held by the main arms 21a and 22a. In the embodiment, an edge portion of the auxiliary arm 30a has a slope. And, the auxiliary arm 30a is located so that the slope of the edge portion adds pressing force to the corner of the side face of the component 40.

The distance sensors 61 and 62 detect a distance to a face facing the mount face of the component 40. The inclination angle of the component 40 can be detected with use of the detection results of the distance sensors. For example, when the distances detected by the distance sensors are equal to each other, it may be determined that the component 40 is in parallel with the mount face of the substrate. A sensor detecting the inclination optically may be used instead of the distance sensor.

FIG. 5B illustrates a use example of the mounting device 100. The mounting device 100 is used when the component 40 is mounted on a substrate 80 provided on a base 70. The mounting device 100 mounts the component 40 on the substrate 80 by pressing the component 40 to the substrate 80 through dissolved solder.

FIG. 6A illustrates a block diagram of a control system of the mounting device 100. A controller 90 controls the mounting device 100. The controller 90 has a CPU (Central Processing Unit), a RAM (Random Access Memory), a ROM (Read Only Memory) and so on. The controller 90 receives a detection result of the distance sensors 61 and 62, and controls the main arms 21a and 22a and the auxiliary arm 30a.

FIG. 6B illustrates a flow chart of an example of a control of the controller 90. As illustrated in FIG. 6B, the controller 90 controls the main arms 21a and 22a so as to hold side faces of the component 40 facing each other (Step S1). Next, the controller 90 controls the main arms 21a and 22a so as to press the component 40 to the mount face of the substrate 80 through dissolved solder on the substrate 80′ (Step S2). In this case, the component 40 gets inclined with respect to the mount face of the substrate 80 because of the pressure of the solder. In concrete, an opposite side across the gravity center of the component 40 from the positions held by the two main arms 21a and 22a floats. Next, the controller 90 determines whether the component 40 is inclined or not based on the detection results of the distance sensors 61 and 62 (Step S3).

If it is determined as “No” in the Step S3, the controller 90 executes the Step S3 again. If it is determined as “Yes” in the Step S3, the controller 90 controls the auxiliary arm 30a so as to press another position across the gravity center of the component 40 from the positions held by the main arms 21a and 22a (Step S4). Thus, the component 40 is mounted in parallel with the mount face of the substrate. After that, the execution of the flow chart is terminated.

In the flowchart of FIG. 6B, the inclination angle or a float amount of the component 40 may be calculated. The inclination angle and the float amount can be calculated according to the detection result of the distance sensors 61 and 62. When the inclination angle and the float amount are calculated, a pressing amount (a distance) of the component 40 for arranging the component 40 in parallel with the mount face of the substrate 80 is determined. Thus, an operating amount (an operating distance) of the auxiliary arm 30a is determined.

### Modified Embodiment

FIG. 7A illustrates a perspective view of a mounting device 100a in accordance with a modified embodiment. As illustrated in FIG. 7A, the mounting device 100a has an arm portion 20b instead of the arm portion 20a having the two main arms 21a and 22a. The arm portion 20b is an adsorption collet. In concrete, the arm portion 20b has a pipe shape, and holds the component 40 by absorbing the component 40 with use of negative pressure in the pipe.

It is not necessary to hold the component 40 by two arms. For example, the component 40 may be held at a single position. However, the position of the component 40 to which the pressing force is added by the auxiliary arm 30a is across the gravity center of the component 40 from the position held by the arm portion 20b.

The component 40 is inclined to only one direction with the method for holding the component 40 in accordance with the first embodiment or the second embodiment. However, in the modified embodiment, the inclination direction is difficult to be determined. And so, another auxiliary arm may be provided in order to keep the component in parallel with the mount face of the substrate. For example, as illustrated in FIG. 7B, auxiliary arms 21b through 23b may be provided so as to be in contact with a side face that is different from the side face to which the auxiliary arm 30a adds the pressing force. In this case, the arm portion 20b picks up the component 40, the arm portion 20b and the auxiliary arms 21b through 23b adjust the position of the component 40, and the auxiliary arm 30a adjusts the posture of the component 40.

The present invention is not limited to the specifically disclosed embodiments and variations but may include other embodiments and variations without departing from the scope of the present invention.

What is claimed is:

1. A mounting method comprising:
holding a component at a position off a gravity center of the component;
pressing the component to a solder provided on a mount face of a substrate; and
adding pressing force to an opposite position of the component across the gravity center from the position held in the pressing of the component toward the mount face, after the pressing of the component.

2. The method as claimed in claim 1, wherein two side faces of the component facing each other are held in the pressing of the component.

3. The method as claimed in claim 1, wherein the component is held with adsorption in the pressing of the component.

4. The method as claimed in claim 1, wherein the pressing force is added to a corner of an upper face of the component in the adding of the pressing force.

5. The method as claimed in claim 1, wherein the solder is AuSn or Ag paste.

6. A mounting device comprising:
a holding member to hold a component off a gravity center thereof; and
an auxiliary member to add pressing force to an opposite position across the gravity center from the position held by the holding member,
the auxiliary member adding pressing force to the component toward a mount face of a substrate after pressing the component to the mount face with the component being held by the holding member, a solder being sandwiched between the component and the mount face of the substrate.

7. The mounting device as claimed in claim 6, wherein the holding member holds two side faces of the component facing each other.

8. The mounting device as claimed in claim 6, wherein the holding member holds the component by adsorption.

9. The mounting device as claimed in claim 6, wherein the auxiliary member adds the pressing force to a corner of an upper face of the component.

10. A mounting jig comprising:
two main arms to hold two side faces of a component facing each other; and
an auxiliary arm to move in a direction that is vertical to a moving direction of the two main arms.

11. The mounting jig as claimed in claim 10, wherein the auxiliary arm is longer than the two main arms.

12. The mounting jig as claimed in claim 11 further comprising a position adjust member to adjust a relative position between an edge of the auxiliary arm and an edge of the two main arms.
